(19) United States
(12) Patent Application Publication
(10) Pub. No.: US 2006/0291147 A1
(43) Pub. Date: Dec. 28, 2006

(54) Multimedia player for an automobile

(75) Inventor: Jui-Chiang Lin, Hsinchu City (TW)

Correspondence Address: BRUCE H. TROXELL, SUITE 1404, 5205 LEESBURG PIKE, FALLS CHURCH, VA, 22041, US

(73) Assignee: Lite-On It Corporation

(21) Appl. No.: 11/415,250

(22) Filed: May 2, 2006

(30) Foreign Application Priority Data
Jun. 28, 2005 (TW) 94121649

(51) Int. Cl. H02B 1/00

(52) U.S. Cl. 361/600

(57) ABSTRACT

A multimedia player for an automobile includes the assembly of a disk drive and a display device mounted movably within an outer casing. The disk drive includes an entrance-and-exit slot via which a disk can be inserted into or ejected from the disk drive. A driving mechanism drives the assembly with respect to the outer casing between a protruded position, in which the disk drive and the display device are protruded from the outer casing, and a retracted position, in which the disk drive and the display device are retracted into the outer casing.

### FIELD OF THE INVENTION

The present invention relates to a multimedia player, and more particularly to a multimedia player for an automobile.

### BACKGROUND OF THE INVENTION

A multimedia player installed in an automobile usually contains a disk drive for driving a disc. A disk drive of slot-in type is preferred in an automobile when compared to the conventional ones due to its portability and compact size (since slot-in type disk drive has no disk tray). The slot-in type disk drive has a disk receiving chamber and an entrance for inserting a disk into and ejecting the same from the chamber.

Presently, the conventional multimedia player further includes a display device for displaying producing the audio-and-video data.

It is noted that the slot-in type disk drive of the conventional multimedia player is usually installed fixedly on the desk board of the automobile, and its entrance is always exposed to the external surroundings. Therefore, the dirt or pollutant may enter the inner side of the disk drive via the entrance and cause damage to the disk drive.

Moreover, the display device of the conventional multimedia player can be installed fixedly at different positions in an automobile, such as at the rooftop, on the desk board, at the backrest of the driver's seat or at a headrest of the seat. Regardless of the installed position of the display device, the display device is still exposed to the surroundings. Under this condition, the display device may damaged by accidental collisions or cause some undesired inconvenience to the user or the driver of the automobile.

Therefore, the present invention is to find a way to improve the structure of the multimedia player for overcoming the drawbacks of the conventional multimedia player mentioned above.

### SUMMARY OF THE INVENTION

The object of the present invention is to improve the structure of a multimedia player for an automobile such that a disk drive and a display device of the multimedia player can be hidden to prevent the dirt or pollutant from entering the inner side of the disk drive and avoid accidental collisions damaging the display device.

According to the present invention, a multimedia player is provided to include: an outer casing with an entrance; a disk drive disposed within the outer casing with an entrance-and-exit slot via which a disk is inserted into and ejected from the disk drive; a display device disposed within the outer casing and associated with the disk drive in such a manner that it is moved together with the disk drive; and a driving mechanism for driving the disk drive together with the display device to move with respect to the outer casing between a protruded position, in which the disk drive and the display device are protruded from the outer casing via the entrance and a retracted position, in which the disk drive and the display device are retracted into the outer casing.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a multimedia player of the present invention;

FIG. 2 is a partially exploded bottom view of the multimedia player of the present invention;

FIG. 3 is a top view of the multimedia player of the present invention;

FIG. 4 shows a first installation type illustrating how the multimedia player of the present invention is mounted within an automobile;

FIG. 5 shows a second installation type illustrating how the multimedia player of the present invention is mounted within the automobile;

FIG. 6 shows a third installation type illustrating how the multimedia player of the present invention is mounted within the automobile; and

FIG. 7 shows a fourth installation type illustrating how the multimedia player of the present invention is mounted within the automobile.

### DETAILED DESCRIPTIONS OF THE PREFERRED EMBODIMENT

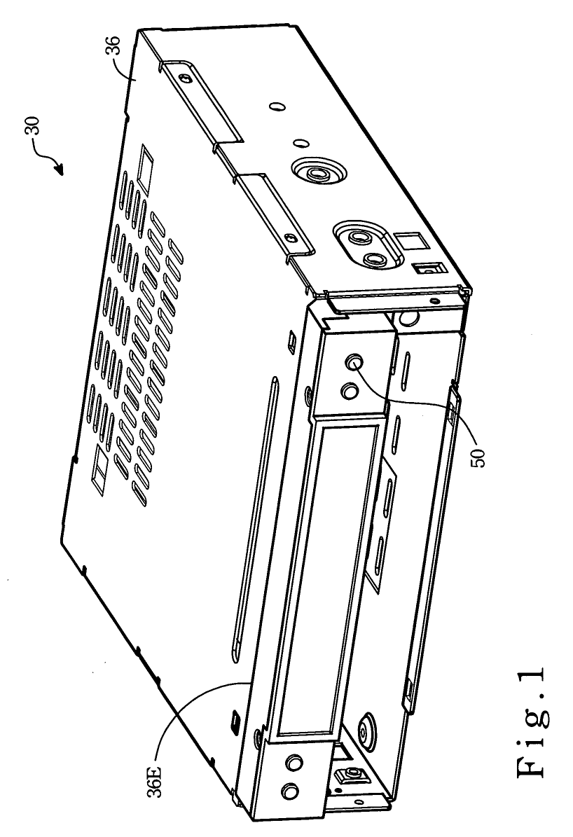

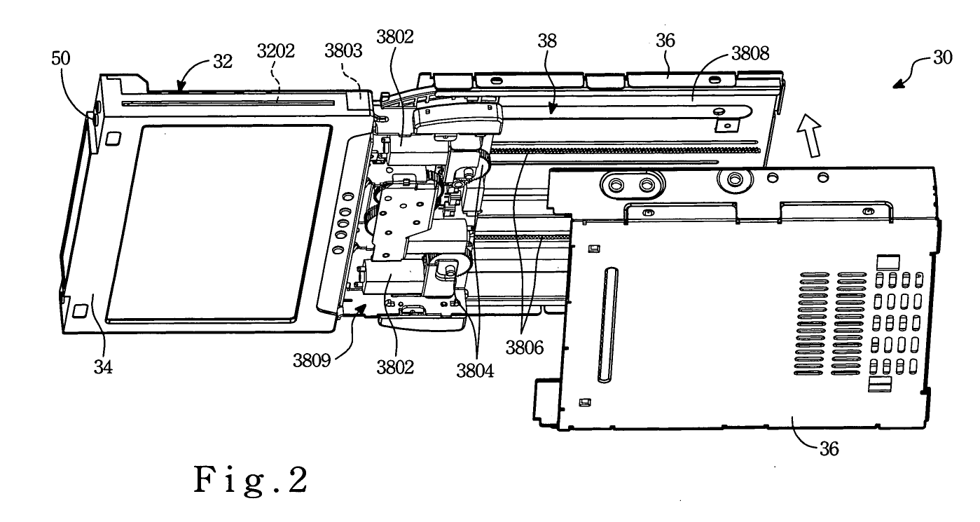

Referring to FIG. 1, a perspective view of a multimedia player 30 of the present invention is shown. FIG. 2 is a partially exploded bottom view of the multimedia player 30 including an outer casing 36, a disk drive 32, a display device 34 and a driving mechanism 38.

The outer casing 36 has an entrance 36E. The disk drive 32 is disposed within the outer casing 36 and has an entrance-and-exit slot 3202 via which the disk is inserted into and ejected from the disk drive 32. The display device 34 is disposed within the outer casing 36 and is associated with the disk drive 32 in such a manner that they are moved together out of the outer casing 36 via the entrance 36E. In this embodiment, the disk drive 32 is a disk drive of slot-in type, and some flat display devices 34, such as TFT LCD (thin-film-transistor Liquid Crystal Display), STN LCD (Super Twist Nematic Liquid Crystal Display) can be used. Alternately, other display devices 34, such as OLED (Organic Light Emitting Diode) and PLED (Polymer Organic Light Emitting Diode) can also be employed in the multimedia displayer 30 of the present invention.

The driving mechanism 38 is used for driving the disk drive 32 together with the display device 34 to move with respect to the outer casing 36 between a protruded position and a retracted position. As shown in FIG. 2, when a user wants to use the multimedia player 30, the disk drive 32 and the display device 34 are simultaneously moved to the protruded position via the entrance 36E of the outer casing 36 so as to be exposed outwardly from the outer. casing 36. When the user does not want to use the multimedia player 30, the disk drive 32 and the display device 34 are retracted simultaneously into the outer casing 36.

The driving mechanism 38 includes a coupling member 3809, a pivot member 3803, a base plate 3808 fixed within the outer casing 36, a pair of racks 3806, a motor unit consisting of two motors 3802 and a transmission gear set consisting of two gears 3804.

The base plate 3808 is mounted securely on the inner surface of the outer casing 36. The racks 3806 are mounted on the base plate 3808, and extend inwardly into the outer casing 36 from the entrance 36E. The disk drive 32 together with the display device 34 is connected to the coupling member 3809. The motors 3802 and the gears 3804 are mounted on the coupled member 3809. Each of the gears 3804 is associated with the respective motor 3802 and engages the respective rack 3806 so as to drive the disk drive 32 and the display device 34 between the protruded and the retracted positions.

In this embodiment, the display device 34 is coupled to an outer surface of the disk drive 32 so as to be co-movable therewith. The pivot member 3803 extends through the assembly of the disk drive 32 and the display device 34 in order to mount the assembly pivotally onto the coupled member 3809 such that when the disk drive 32 together with the display device 34 is disposed at the protruded position, the disk drive 32 together with the display device 34 can be rotated with respect to the outer casing 36.

In this embodiment, the entrance-and-exist slot 3202 is disposed at a lateral side of the disk drive 32. When the disk drive 32 is disposed at the protruded position, the entrance-and-exist slot 3202 in the disk drive 32 is exposed, as shown in FIG. 2. When the disk drive 32 is disposed at the retracted position, the outer casing 36 conceals the entrance-and-exit slot 3202 of the disk drive 32. Under this condition, dirt and waste are prevented from entering into the disk drive 32 via the entrance-and-exit slot 3202, thereby protecting the reading head in the disk drive 32.

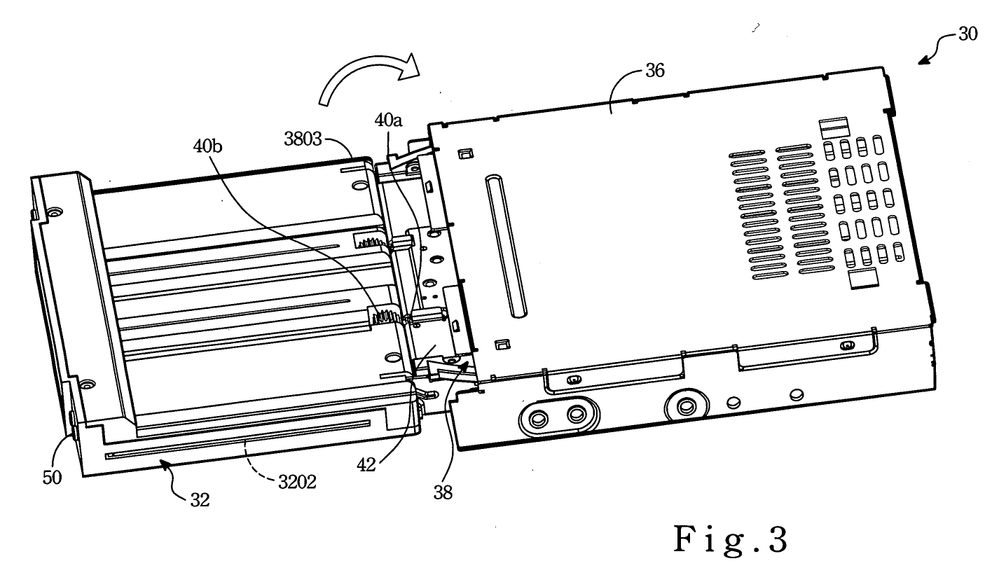

Referring to FIG. 3, the driving mechanism 38 further includes a pair of drive gears 40a coupled to the motors 3802 respectively and a pair of driven gears 40b that are fixed on the pivot member 3803. The driven gears 40b are respectively meshed with the drive gears 40a. Under this arrangement, when the disk drive 32 is disposed at the protruded position, activation of the motors 3802 enables rotation of the disk drive 32 together with the display device 34 with respect to the outer casing 36.

Referring again to FIGS. 1 and 2, a press button 50 is provided on a front side of the disk drive 32. The press button 50 is electrically connected to the driving mechanism 38 for sending a signal to actuate the driving mechanism 38.

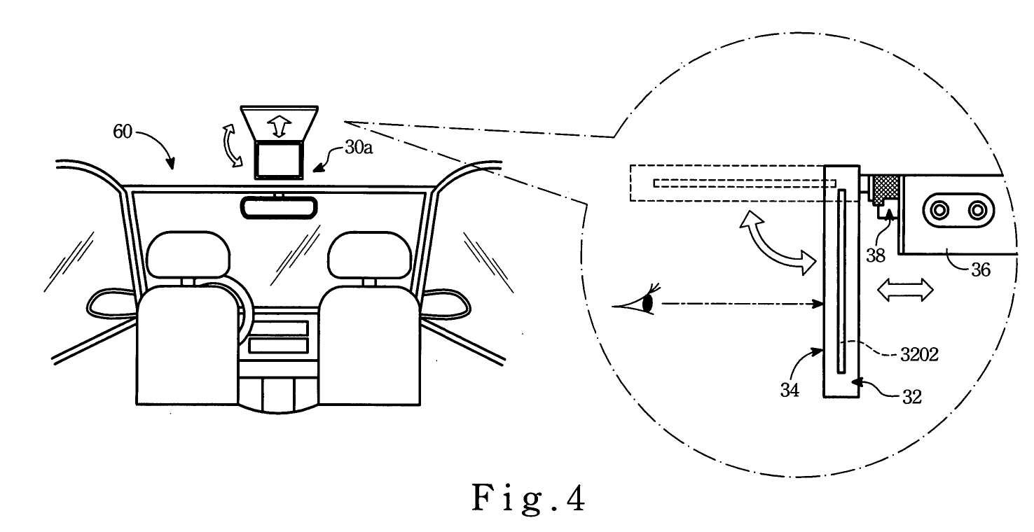

FIG. 4 shows a first installation type illustrating how the multimedia player 30a of the present invention is mounted within an automobile. The outer casing 36 is fixed to the rooftop of the automobile. In use, the disk drive 32 together with the display device 34 is moved to the protruded position and tilted downward from the out casing 36 so as to provide a comfortable viewing angle to the persons seated in the automobile.

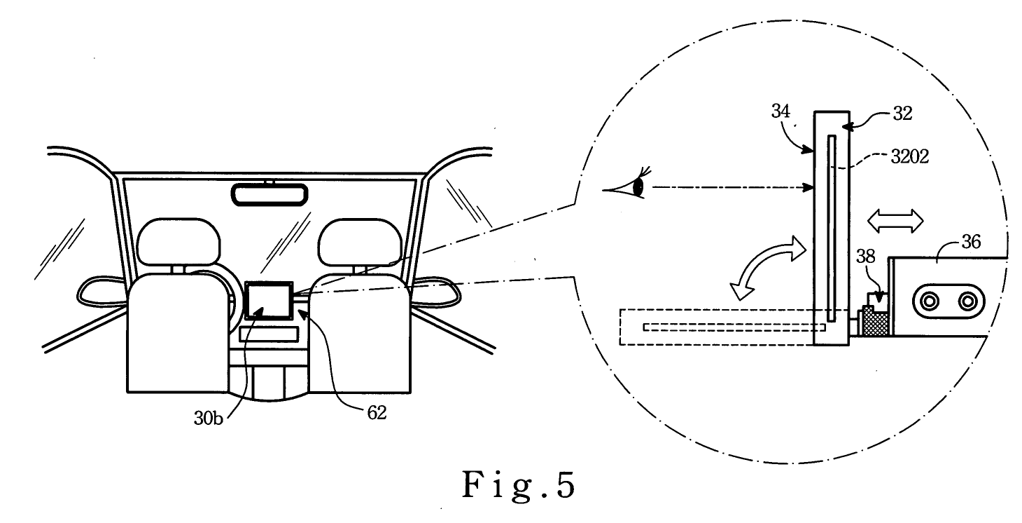

FIG. 5 shows a second installation type illustrating how the multimedia player 30b of the present invention is mounted within the automobile. The outer casing 36 is fixed to the desk board of the automobile. In use, the disk drive 32 together with the display device 34 is moved to the protruded position and tilted perpendicularly upward from the outer casing 36 so as to provide a comfortable viewing angle to the persons seated in the automobile.

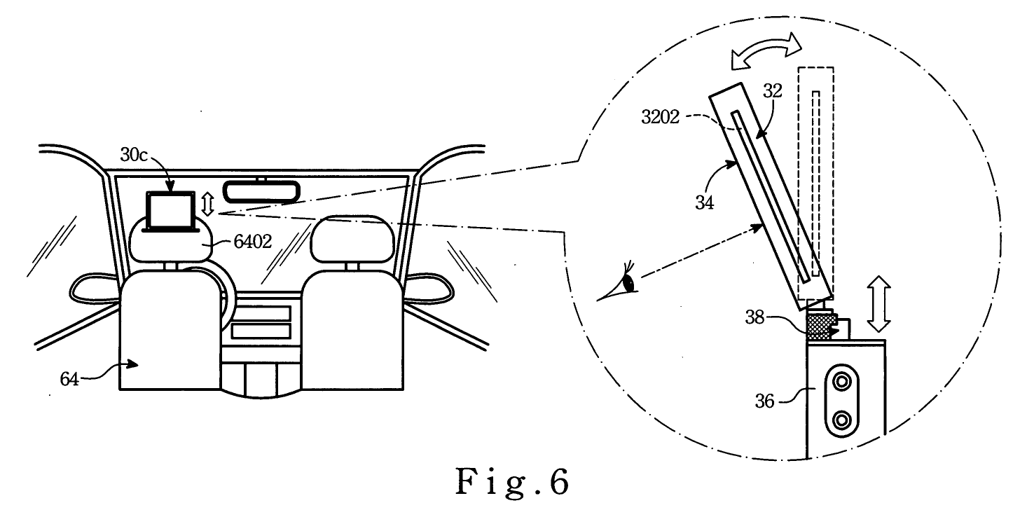

FIG. 6 shows a third installation type illustrating how the multimedia player 30c of the present invention is mounted within the automobile. The outer casing 36 is fixed to the headrest 6402 of the driver's seat 64. In use, the disk drive 32 together with the display device 34 is moved to the protruded position and tilted slightly forward from the outer casing 36 so as to provide a comfortable viewing angle to the persons seated in the automobile.

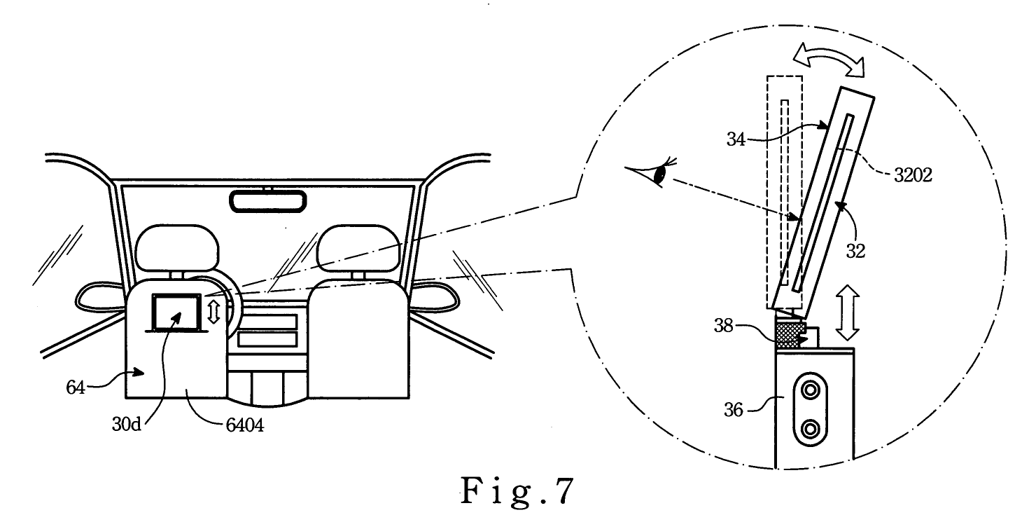

FIG. 7 shows a fourth installation type illustrating how the multimedia player 30d of the present invention is mounted within the automobile. The outer casing 36 is fixed to the backrest 6404 of the driver's seat 64. In use, the disk drive 32 together with the display device 34 is moved to the protruded position and tilted slightly backward from the outer casing 36 so as to provide a comfortable viewing angle to the persons seated in the automobile.

In summary, since the disk drive 32 and the display device 34 are coupled together and can be retracted in the outer casing 36, undesired collisions to the display device 34 can be avoided. In addition, since the outer casing 36 can conceal the entrance-and-exit slot 3202 of the disk drive 32, and dirt cannot enter the disk drive 32 via the entrance-and-exit slot 3202, thereby protecting the reading head in the disk drive 32 and prolonging the service life of the multimedia player 30 of the present invention.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A multimedia player for an automobile comprising:
an outer casing having an entrance;
a disk drive disposed within said outer casing and having an entrance-and-exit slot via which a disk is inserted into and ejected from said disk drive;
a display device disposed within said outer casing and associated with said disk drive in such a manner that said display device is moved together with said disk drive; and
a driving mechanism for driving said disk drive together with said display device to move with respect to said outer casing between a protruded position, in which said disk drive and said display device are protruded from said outer casing via said entrance, and a retracted position, in which said disk drive and said display device are retracted into said outer casing.

2. The multimedia player according to claim 1, wherein said display device is a LCD (liquid crystal display).

3. The multimedia player according to claim 1, wherein said display device is an OLED (organic light emitting diode).

4. The multimedia player according to claim 1, wherein said driving mechanism includes a pivot member, and said disk drive and said display device are coupled pivotally to said driving mechanism via said pivot member such that said disk drive and said display device can be rotated about said pivot member.

5. The multimedia player according to claim 4, wherein said driving mechanism includes a motor unit, a drive gear coupled to and driven by said motor unit and a driven gear fixed on said pivot member and meshed with said drive gear such that activation of said motor unit enables rotation of said disk drive and said display device about said pivot member.

6. The multimedia player according to claim 1, wherein said display device is mounted on an outer surface of said disk drive so as to be moved together therewith.

7. The multimedia player according to claim 1, wherein said driving mechanism includes a base plate fixed within said outer casing, at least one rack mounted on said base plate, a coupling member, a motor unit mounted on said coupling member, and at least one gear associated with said motor unit and engaging said rack so as to move said disk drive and said display device between said protruded position and said retracted position.

8. The multimedia player according to claim 7, wherein said disk drive together with said displayer is pivotally connected to said coupling member.

9. The multimedia player according to claim 1, wherein said entrance-and-exit slot is disposed at a lateral side of said disk drive.
